(19) United States
(12) Patent Application Publication
(10) Pub. No.: US 2015/0318565 A1
(43) Pub. Date: Nov. 5, 2015

(54) SYSTEM AND METHOD OF CONTROLLING FUEL CELL VEHICLE

(71) Applicant: HYUNDAI MOTOR COMPANY, Seoul (KR)

(72) Inventors: Jung Hwan Ryu, Suwon (KR); Ja Hoo Koo, Yongin (KR)

(21) Appl. No.: 14/553,466

(22) Filed: Nov. 25, 2014

(30) Foreign Application Priority Data
May 2, 2014 (KR) 10-2014-0053222

(51) Int. Cl. H01M 8/04

(52) U.S. Cl. CPC H01M 8/0494; H01M 8/04619

(57) ABSTRACT

A system and method of controlling a fuel cell vehicle are provided. The method includes adjusting power output from a plurality of fuel cell stacks based on entire output power required by a fuel cell vehicle and a state of charge (SOC) of a battery.

### CROSS-REFERENCE(S) TO RELATED APPLICATION

The present application claims priority of Korean Patent Application Number 10-2014-0053222 filed on May 2, 2014, the entire contents of which application are incorporated herein for all purposes by this reference.

### BACKGROUND

1. (a) Technical Field

The present invention relates to a system and method of controlling a fuel cell vehicle, and more particularly, to a method of controlling a fuel cell vehicle through which a plurality of fuel cell modules are selected and driven according to a required output by configuring the plurality of fuel cell stack modules in parallel.

2. (b) Description of the Related Art

A fuel cell vehicle includes a fuel cell stack in which a plurality of fuel cell cells used as a power source are stacked, a fuel supply system configured to supply a fuel such as hydrogen to the fuel cell stack, an air supply system configured to supply an oxidizer such as oxygen, which is necessary for an electrical/chemical reaction, and a water/heat management system configured to adjust a temperature of the fuel cell stack.

The fuel supply system reduces a pressure of compressed hydrogen in the interior of a hydrogen tank to supply the compressed hydrogen to a fuel electrode (anode) of the stack, and the air supply system operates an air blower to supply the suctioned exterior air to an air electrode (cathode) of the stack.

When hydrogen is supplied to the fuel electrode of the stack and oxygen is supplied to the air electrode, hydrogen ions are separated from the fuel electrode through a catalytic reaction. The separated hydrogen ions are transferred to an oxidation electrode, which is the air electrode, through an electrolyte membrane, and the hydrogen ions separated from the fuel electrode, electrons, and oxygen generates an electrical/chemical reaction in the oxidation electrode to obtain electrical energy. In particular, an electrical/chemical oxidation of hydrogen is generated in the fuel electrode and an electrical/chemical reduction of oxygen is generated in the air electrode, in which case electric power and heat are generated due to flows of the generated electrons and vapor or water is generated due to a chemical reaction in which hydrogen and oxygen are bonded to each other.

A discharge apparatus configured to discharge side products such as vapor, water, and heat generated in a process of generating electrical energy of the fuel cell stack and hydrogen, oxygen, and the like which are not reacted is provided, and the gases such as vapor, hydrogen, and oxygen are discharged to the atmosphere through an exhaust passage.

Meanwhile, fuel cell hybrid vehicles have been developed to supplement disadvantages that may occur when only fuel cells are used as a power source of a vehicle. The fuel cell hybrid vehicle includes a high voltage battery or a super capacitor in addition to a fuel cell, which is a main power source. The fuel cell hybrid vehicle receives hydrogen from a hydrogen tank and receives air from an air blower to use fuel cells generating electric power due to electrical/chemical reactions of hydrogen, and oxygen in air as a main power source. A driving motor and a motor control unit (MCU) are directly connected to a fuel cell via a main bus terminal, and a super capacitor is connected to an initial charging unit for assisting of power and regenerative braking. A low voltage direct current-direct current (DC/DC) converter (LDC) for conversion of an output between a high voltage and a low voltage and a low voltage battery for driving components are connected to the main bus terminal.

Configurations such as an air blower for driving a fuel cell, a hydrogen recirculating blower, and a water pump are connected to the main bus terminal to facilitate startup of the fuel cell, and various relays for facilitating shut off or connection of electric power and diodes for preventing current from reversely flowing to the fuel cell may be connected to the main bus terminal. Dry air supplied through the air blower is humidified through a humidifier and is supplied to a cathode (air electrode) of the fuel cell stack, and exhaust gas of the cathode may be transferred to the humidifier while being humidified by water substances generated in the cathode to be used to humidify dry air, which will be supplied to the cathode by the air blower.

Meanwhile, output power of the fuel cell may be adjusted as an output current of the fuel cell, in which case durability of the fuel cell may deteriorate when the fuel cell is continuously used in a high voltage area, that is, a low output area. A low output avoidance operation is performed to prevent the battery from being charged for a low output and accordingly, a capacity of a battery to which regenerative brake energy is to be charged may not be secured and fuel ratio of the vehicle is may be negatively badly.

The description provided above as a related art of the present invention is merely for helping in understanding the background of the present invention and should not be construed as being included in the related art known by those skilled in the art.

### SUMMARY

The present invention provides a method of controlling a fuel cell vehicle through which a plurality of fuel cell modules may be selected and driven according to a required output by configuring the plurality of fuel cell modules in parallel.

In one aspect, the present invention provides a method of controlling a fuel cell vehicle that may include: adjusting power output from a plurality of fuel cell stacks based on entire output power required by a fuel cell vehicle and a state of charge (SOC) of a battery.

The adjustment of the output power may include adjusting output power by selecting and driving at least one of the plurality of fuel cell stacks. The required entire output power may be greater than maximum output power of M fuel cell stacks of the plurality of fuel cell stacks and less than maximum output power of (M+1) fuel cell stacks of the plurality of fuel cell stacks. When the SOC of the battery is less than a preset SOC, the output power may be adjusted by setting a voltage of one of the (M+1) fuel cell stacks to a preset maximum allowable voltage. Power output from M fuel cell stacks of the (M+1) fuel cell stacks may be adjusted to maximum power.

The method may further include: when the SOC of the battery is greater than a preset SOC, comparing a magnitude of power output when power output from M fuel cell stacks among the (M+1) fuel cell stacks is adjusted to maximum power and a voltage of remained fuel cell stack is set to a preset maximum allowable voltage with a magnitude of the required entire output power of the battery. In the comparison result, when the magnitude of the required entire output power of the battery is less than a sum of maximum power of M fuel cell stacks and power output when the remaining fuel cell stack is set to a maximum allowable voltage, power output from one of the (M+1) fuel cell stacks may be adjusted to about 0.

In the comparison result, when the magnitude of the required entire output power of the battery is greater than a sum of maximum power of M fuel cell stacks and power output when the remaining fuel cell stack is set to a maximum allowable voltage, a voltage of one of the (M+1) fuel cell stacks may be adjusted to the preset maximum allowable voltage. Power output from M fuel cell stacks of the (M+1) fuel cell stacks may be adjusted to a maximum value. As the required entire output power increases, the number of fuel cell stacks of the plurality of fuel cell stacks, which may be configured to output power, may increase. Power output from the plurality of fuel cell stacks may be adjusted by driving a stopped fuel cell stack as the required entire output power increases.

When maximum output power of a plurality of driven fuel cell stacks of the plurality of fuel cell stacks is less than the required entire output power, power output from the plurality of fuel cell stacks may be adjusted by driving a stopped fuel cell stack. Further, power output from the battery may increase for a time period required (e.g., consumed) to drive a stopped fuel cell stack. When the stopped fuel cell stack is driven after the consumed time period elapses, power output from the battery may decrease.

When the stopped fuel cell stack is in a flooding state (e.g., a first stopped fuel cell stack), power output from the plurality of fuel cell stacks may be adjusted by driving another stopped fuel cell stack (e.g., a second stopped fuel cell stack) other than the stopped fuel cell stack in the flooding state. When the stopped fuel cell stack is driven, power output from the stopped fuel cell stack may be adjusted according to the SOC of the battery. When the SOC of the battery is less than a preset SOC, a voltage of the stopped fuel cell stack may be set to a preset maximum allowable voltage. When the SOC of the battery is greater than a preset SOC, preset output power which may be output from the stopped fuel cell stack may be compared with maximum output power of the battery.

In the comparison result, when preset output power which may be output from the stopped fuel cell stack is less than maximum output power of the battery, the stopped fuel cell stack may not be driven. In the comparison result, when preset output power which may be output from the stopped fuel cell stack is greater than maximum output power of the battery, the power output from the stopped fuel cell stack may be adjusted to the preset output power.

### BRIEF DESCRIPTION OF THE DRAWINGS

The above and other features of the present invention will now be described in detail with reference to exemplary embodiments thereof illustrating the accompanying drawings which are given herein below by way of illustration only, and thus are not limitative of the present invention, and wherein:

FIG. 1 is an exemplary view showing a parallel connection of fuel cell stack modules according to an exemplary embodiment of the present invention; and

FIG. 2 is an exemplary graph showing a relationship between outputs of a plurality of fuel cell stack modules according to an exemplary embodiment of the present invention and an output of a battery and a required output.

It should be understood that the appended drawings are not necessarily to scale, presenting a somewhat simplified representation of various exemplary features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various exemplary embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover the exemplary embodiments as well as various alternatives, modifications, equivalents and other embodiments; which may be included within the spirit and scope of the invention as defined by the appended claims.

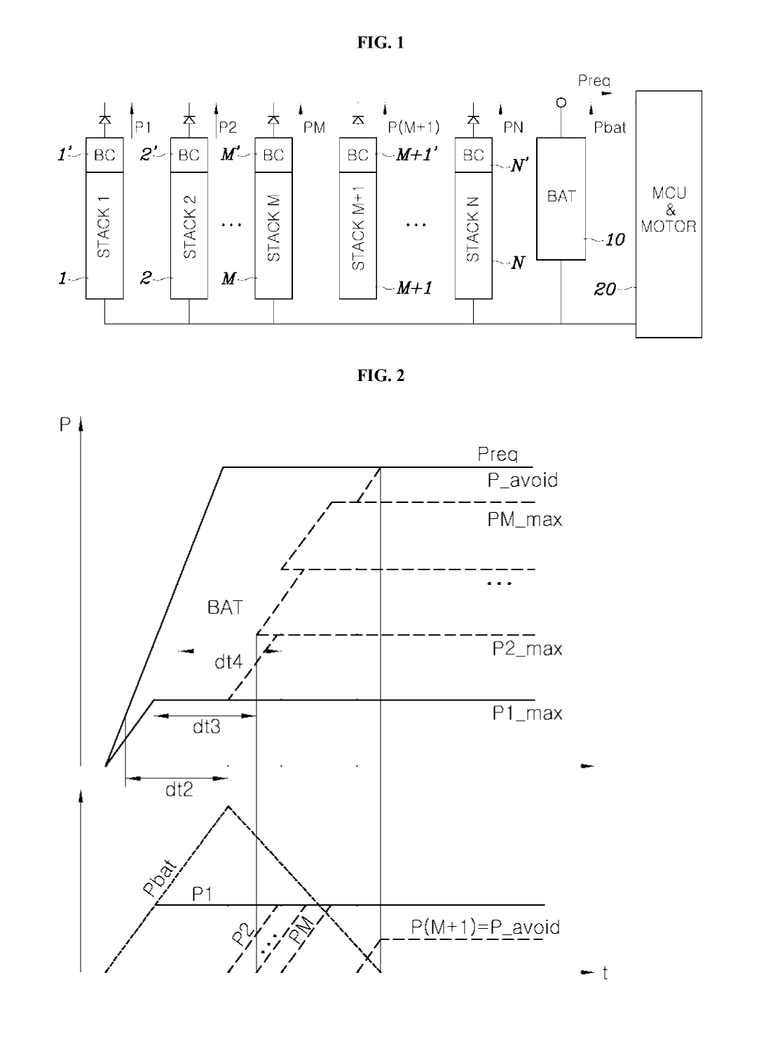

Exemplary embodiments of the present invention will be described with reference to the accompanying drawings (FIGS. 1 and 2). Throughout the specification, the operation subject may be a fuel cell controller (FCU). The fuel cell controller may be an integrated controller for a plurality of individual controllers constituting a fuel cell vehicle. FIG. 1 is an exemplary view showing a parallel connection of fuel cell stack modules according to an exemplary embodiment of the present invention. FIG. 2 is an exemplary graph showing a relationship between outputs of a plurality of fuel cell stack modules according to an exemplary embodiment of the present invention and an output of a battery and a required output.

The method of controlling a fuel cell vehicle according to an exemplary embodiment of the present invention may include adjusting, by a controller, power output from a plurality of fuel cell stacks based on entire output power required by the fuel cell vehicle and a state of charge (SOC) of a battery. In other words, driving power of the fuel cell vehicle may be provided by a plurality of fuel cell stack modules 1, 2, . . . , M, M+1, . . . , and N and a battery 10. The driving power may be used to drive a vehicle using a motor controller and a motor 20.

In an exemplary embodiment of the present invention, when a total number of fuel cell stacks is N, power P1 output from a first fuel cell stack 1 to the motor 20 through a corresponding boost converter 1′, power P2 output from a second fuel cell stack 2 to the motor 20 through a corresponding boost converter 2′, powers output from a third fuel cell stack (not shown), a fourth fuel cell stack (not shown), and the like continuously connected in parallel to each other to the motor 20, power PM output from an M-th fuel cell stack M to the motor 20 through a corresponding boost converter M′, power P(M+1) output from an (M+1)-th fuel cell stack M+1 to the motor 20 through a corresponding boost converter M+1′, power PN continuously connected in parallel to be connected from a N-th fuel cell stack N to the motor 20 through a corresponding boost converter N′, and power Pbat output from the battery 10 may be added and output to the motor 20. The plurality of fuel cell stacks 1, 2, . . . , M, M+1, . . . , and N may be selectively driven according to entire output power Preq required by the motor 20 and a state of charge (SOC) of the battery 10.

For example, when the magnitude of the output required during an operation in a downtown area (e.g., a substantially congested area) is minimal, the fuel cell vehicle may be driven by power output from the first fuel cell stack 1. Accordingly, in this case, the remaining fuel cell stacks 2, . . . , M, M+1, . . . , and N other than the first fuel cell stack 1 may be in a driving stopped state. As entire output power required by the motor 20 increases, the number of driven fuel cell stacks may increase. In other words, the fuel cell controller (not shown) may be configured to select and drive at least one of the plurality of fuel cell stacks according to entire output power Preq required by the fuel cell vehicle and an SOC of the battery 10 to adjust the output power.

In particular, when the required entire output power Preq is greater than the sum of maximum output power of each of the M fuel cell stacks 1, 2, . . . , and M of the plurality of fuel cell stacks 1, 2, . . . , M, M+1, . . . , and N and less than the sum of maximum output power of each of the (M+1) fuel cell stacks 1, 2, . . . , M, and M+1) of the plurality of fuel cell stacks 1, 2, . . . , M, M+1, . . . , and N, the fuel cell controller may be configured to set a voltage of one of the (M+1) fuel cell stacks 1, 2, . . . , M, and M+1, for example, the (M+1)-th fuel cell stack M+1 may be set to a preset maximum allowable voltage when the SOC of the battery 10 is less a preset SOC. The maximum allowable voltage may be a preset maximum voltage for avoiding a substantially high voltage in one fuel cell stack. Due to the durability of a fuel cell stack potentially deteriorating when continuously used in a substantially high-voltage area, the preset maximum allowable voltage may be a maximum allowable voltage which may prevent the durability of the fuel cell stack from deteriorating.

Then, the power output from M fuel cell stacks of the (M+1) fuel cell stacks 1, 2, . . . , M, and M+1 may be adjusted to maximum output power. For example, although the first to M-th fuel cell stacks 1, 2, . . . , and M show the maximum output power, the maximum output power may be less than the required entire output power Preq. Accordingly, one fuel cell stack M+1 may be additionally driven, in which case a voltage of the fuel cell stack M+1 may be adjusted to prevent power from being output in a substantially low output power section of which output power is sufficient to deteriorate durability of the fuel cell stack. When the SOC of the battery 10 is greater than a preset SOC, the fuel cell controller may be configured to compare power P_avoid output when a voltage of one fuel cell stack M+1 of the (M+1) fuel cell stacks 1, 2, . . . , M, and M+1 is set to a preset maximum allowable voltage with maximum output power Pbat_max of the battery 10.

In the comparison result, when the maximum output power Pbat_max of the battery 10 is greater than the power P_avoid output for the maximum allowable voltage, the fuel cell controller may be configured to adjust power output from one M+1 of the (M+1) fuel cell stacks to 0. Accordingly, the required entire output power Preq may be a sum of power P1_max+P2_max+ . . . +PM_max output from the M fuel cell stacks 1, 2, . . . , and M and power Pbat output from the battery 10.

Further, when the maximum output power of the battery 10 is less than the power P_avoid output for the maximum allowable voltage, the fuel cell controller may be configured to set a voltage of one M+1 of the (M+1) fuel cell stacks 1, 2, . . . , M, and M+1 to a preset maximum allowable voltage. Accordingly, power output from one M+1 of the (M+1) fuel cell stacks 1, 2, . . . , M, and M+1 may be P_avoid. Power output from the M fuel cell stacks 1, 2, . . . , and M of the (M+1) fuel cell stacks 1, 2, . . . , M, and M+1 may be adjusted to a maximum value. Accordingly, the required entire output power Preq may be a sum of power P1_max+P2_max+ . . . +PM_max output from the M fuel cell stacks 1, 2, . . . , and M, power PM+1 output from the (M+1)-th fuel cell stack M+1, and power Pbat output from the battery 10.

In other words, the number of driven fuel cell stacks may vary according to the magnitude of the required entire output power Preq. As the magnitude of the required entire output power Preq increases, the number of fuel cell stacks configured to output power among the plurality of fuel cell stacks 1, 2, . . . , M, M+1, . . . , and N may increase. The stopped fuel cell stack may be driven as the required entire output power Preq increases to adjust power output from the plurality of fuel cell stacks 1, 2, . . . , M, M+1, . . . , and N.

With the assumption that a plurality of driven fuel cell stacks of the plurality of fuel cell stacks 1, 2, . . . , M, M+1, . . . , and N are the first to M-th fuel cell stacks 1, 2, . . . , and M, when the maximum output power is less than the required entire output power Preq, a stopped fuel cell stack M+1 may be newly driven to allow output power of the plurality of fuel cell stacks to be adjusted.

A time period consumed until a new fuel cell stack is additionally driven, that is, a time period required until a stopped fuel cell stack outputs power may be detected. Referring to FIG. 2, a time period consumed until the second fuel cell stack 2 is driven is dt2, a time period consumed until the third fuel cell stack (not shown) is newly driven is dt3, and a time period consumed until the fourth fuel cell stack (not shown) is newly driven is dt4. Accordingly, for a time period consumed to drive the stopped fuel cell stack, the fuel cell controller may be configured to increase power output from the battery 10. As the fuel cell stack is newly driven to output power, power output from the battery 10 also may decrease accordingly.

Meanwhile, when the fuel cell stack which is to be newly driven (e.g., a first fuel cell stack or a newly driven fuel cell stack) cannot be drive due to detecting a flooding state of the fuel cell stack, the fuel cell controller may be configured to drive or operate another stopped fuel cell stack other than the stopped fuel cell stack in a flooding state (e.g., a second fuel cell stack) to adjust the power output from the plurality of fuel cell stacks.

When a stopped fuel cell stack is to be newly driven due to the required entire output power being greater than power output from an existing driven fuel cell stack, the fuel cell controller 10 may be configured to detect an SOC of the battery 10. When the SOC of the battery 10 is less than a preset SOC, the fuel cell controller may be configured to set a voltage of a stopped fuel cell stack to a preset maximum allowable voltage, and accordingly, the stopped fuel cell stack may be configured to output power that corresponds to the maximum allowable voltage.

When the SOC of the battery 10 is greater than a preset SOC, the fuel cell controller may be configured to compare preset output power which may be output from a stopped fuel cell stack with maximum output power Pbat_max of the battery 10. The preset output power may be output power when the voltage of the fuel cell stack is a preset maximum allowable voltage. In the comparison result, when preset output power which may be output from the stopped fuel cell stack is detected to be less than maximum output power of the battery 10, the fuel cell controller may be configured to drive the motor 20 using the output of the battery 10 without driving a stopped fuel cell stack. In addition, when preset output power which may be output from the stopped fuel cell stack is detected to be greater than maximum output power of the battery 10, the fuel cell controller may be configured to adjust power output from the stopped fuel cell stack to preset output power.

According to the method of controlling a fuel cell vehicle according to an exemplary embodiment of the present invention, as a plurality of fuel cell modules are selected and driven according to an output range, a substantially low output area may be avoided and accordingly, durability of a fuel cell stack may be maintained. When fuel cell stack modules other than a selected fuel cell stack module are stopped, consumption of hydrogen may be reduced and overcharging of the battery may be minimized as an entire output of the fuel cell system is reduced. Accordingly, as an absorption rate of regenerative braking energy increases, fuel ratio may be improved.

Although the exemplary embodiments of the present invention has been described with reference to the accompanying drawings, they are merely exemplary, and it is noted by those skilled in the part to which the present invention pertains that various modifications and equivalent embodiments may be made. Accordingly, the genuine technical scope of the present invention should be determined by the spirit of the claims.

What is claimed is:

1. A method of controlling a fuel cell vehicle, comprising:
adjusting, by a controller, power output from a plurality of fuel cell stacks based on entire output power required by a fuel cell vehicle and a state of charge (SOC) of a battery.

2. The method of claim 1, wherein the adjusting of the output power includes:
adjusting, by the controller, output power by selecting and driving at least one of the plurality of fuel cell stacks.

3. The method of claim 1, wherein the required entire output power is greater than maximum output power of M fuel cell stacks of the plurality of fuel cell stacks and less than maximum output power of (M+1) fuel cell stacks of the plurality of fuel cell stacks.

4. The method of claim 3, wherein when the SOC of the battery is less than a preset SOC, the output power is adjusted by setting a voltage of one of the (M+1) fuel cell stacks to a preset maximum allowable voltage.

5. The method of claim 4, wherein power output from M fuel cell stacks of the (M+1) fuel cell stacks is adjusted to maximum power.

6. The method of claim 3, further comprising:
when the SOC of the battery is greater than a preset SOC, comparing, by the controller, a magnitude of power output when power output from M fuel cell stacks among the (M+1) fuel cell stacks is adjusted to maximum power and a voltage of remaining fuel cell stack is set to a preset maximum allowable voltage with a magnitude of the required entire output power of the battery.

7. The method of claim 6, wherein in the comparison result, when the magnitude of the required entire output power of the battery is less than a sum of maximum power of M fuel cell stacks and power output and the remaining fuel cell stack is set to a maximum allowable voltage, power output from one of the (M+1) fuel cell stacks is adjusted to 0.

8. The method of claim 6, wherein in the comparison result, when the magnitude of the required entire output power of the battery is greater than a sum of maximum power of M fuel cell stacks and power output and the remaining fuel cell stack is set to a maximum allowable voltage, a voltage of one of the (M+1) fuel cell stacks is adjusted to the preset maximum allowable voltage.

9. The method of claim 8, wherein power output from M fuel cell stacks of the (M+1) fuel cell stacks is adjusted to a maximum value.

10. The method of claim 1, wherein as the required entire output power increases, the number of fuel cell stacks of the plurality of fuel cell stacks configured to output power, increases.

11. The method of claim 1, wherein power output from the plurality of fuel cell stacks is adjusted by driving a stopped fuel cell stack as the required entire output power increases.

12. The method of claim 1, wherein when maximum output power of a plurality of driven fuel cell stacks of the plurality of fuel cell stacks is less than the required entire output power, power output from the plurality of fuel cell stacks is adjusted by driving a stopped fuel cell stack.

13. The method of claim 11, wherein power output from the battery increases for a time period consumed to drive a stopped fuel cell stack.

14. The method of claim 13, wherein when the stopped fuel cell stack is driven after the consumed time period elapses, power output from the battery decreases.

15. The method of claim 11, wherein when the stopped fuel cell stack is in a flooding state, power output from the plurality of fuel cell stacks is adjusted by driving another stopped fuel cell stack.

16. The method of claim 11, wherein when the stopped fuel cell stack is driven, power output from the stopped fuel cell stack is adjusted according to the SOC of the battery.

17. The method of claim 16, wherein when the SOC of the battery is less than a preset SOC, a voltage of the stopped fuel cell stack is set to a preset maximum allowable voltage.

18. The method of claim 16, wherein when the SOC of the battery is greater than a preset SOC, preset output power output from the stopped fuel cell stack is compared with maximum output power of the battery.

19. The method of claim 18, wherein in the comparison result, when preset output power output from the stopped fuel cell stack is less than maximum output power of the battery, the stopped fuel cell stack maintained in a stopped state.

20. The method of claim 18, wherein in the comparison result, when preset output power output from the stopped fuel cell stack is greater than maximum output power of the battery, power output from the stopped fuel cell stack is adjusted to the preset output power.

21. A system of controlling a fuel cell vehicle, comprising:
a memory configured to store program instructions; and
a processor configured to execute the program instructions, the program instructions when executed configured to:
adjust power output from a plurality of fuel cell stacks based on entire output power required by a fuel cell vehicle and a state of charge (SOC) of a battery by selecting and driving at least one of the plurality of fuel cell stacks.

22. The system of claim 21, wherein the required entire output power is greater than maximum output power of M fuel cell stacks of the plurality of fuel cell stacks and less than maximum output power of (M+1) fuel cell stacks of the plurality of fuel cell stacks.

23. The system of claim 22, wherein when the SOC of the battery is less than a preset SOC, the output power is adjusted by setting a voltage of one of the (M+1) fuel cell stacks to a preset maximum allowable voltage.

24. The system of claim 22, wherein the program instructions when executed are further configured to:
compare a magnitude of power output when power output from M fuel cell stacks among the (M+1) fuel cell stacks is adjusted to maximum power and a voltage of remaining fuel cell stack is set to a preset maximum allowable voltage with a magnitude of the required entire output power of the battery when the SOC of the battery is greater than a preset SOC.
